(19) United States
(12) Patent Application Publication
(10) Pub. No.: US 2021/0207603 A1
(43) Pub. Date: Jul. 8, 2021

(54) INTEGRATED MOTOR PUMP UNIT

(71) Applicant: KSB SAS, Gennevilliers (FR)

(72) Inventors: NICOLAS PETIT, Hazebrouck (FR); Noémie AERNOUT, Sequedin (FR)

(21) Appl. No.: 17/043,848

(22) PCT Filed: Apr. 3, 2019
(86) PCT No.: PCT/EP2019/058433

§ 371 Date: Sep. 30, 2020

(30) Foreign Application Priority Data
Apr. 6, 2018 (FR) 18 70412

(51) Int. Cl. F04D 13/06; H02K 7/14; H02K 11/25

(52) U.S. Cl. CPC F04D 13/0693; H02K 5/225; H02K 11/25; H02K 7/14

(57) ABSTRACT

In this motor pump unit comprising an impeller (1) surrounded by a volute (2) and mounted on the output shaft (3) of an electric motor (4) surrounded by a housing (5) which is closed on the side opposite the impeller (1) by a cover (6), an extension (7) is interposed between the cover (6) and the housing (5) and a sensor (11) for sensing a property of the impeller (1) is housed in the extension (7).

The present invention relates to motor pump units.

A motor pump unit comprising an impeller surrounded by a volute and mounted on the output shaft of an electric motor is known in the art. The electric motor is surrounded by a housing which is closed on the side opposite the impeller by a cover. The volute and the housing may each be formed in one piece or may be in one uninterrupted section. The motor pump unit comprises a control device for the motor which is arranged outside the housing. This requires a shielded connector with good-quality cables with insulated conductor strands, especially when using a frequency inverter, and especially if the control device comprises a frequency inverter.

The object of the invention is to simplify the connector considerably and for the unit itself to be able to detect whether the impeller is working satisfactorily. This means that the unit can be stopped in time, before serious damage arises, or damage leading to significant maintenance problems or problems restarting the unit.

According to the invention, an extension is interposed between the cover and the housing and at least one element with an electrical connection wire is housed in the extension.

The extension may also be an integral part of the cover. In this case, the cover is sufficiently deep to allow it to accommodate an element with an electrical connection wire. The depth of the cover is the dimension of its side face along the axis of the impeller.

The extension provides enough space to enable it to incorporate the at least one element in the unit. In this way, the control device for the motor can be housed in the extension and said control device can be connected to the motor by means of a first wire. The motor control device is also understood to mean the motor starting circuit, the extension also being used to house the capacitor used for this purpose. According to the invention, said extension houses a sensor for sensing a property of the impeller, which is connected by at least one second wire to the impeller. The sensor may be a sensor to sense the rotation speed of the impeller. It may also be a sensor to detect a difference between the discharge pressure and the suction pressure. It may be a sensor to detect impeller vibrations or a probe to detect the temperature of the fluid carried by the unit or the temperature of the packing boxes or bearings of the impeller. The extension can be used to house any wired element associated with operation of the motor pump unit.

A first seal is arranged between the extension and the housing and, likewise, a second seal ensures leaktightness between the cover and the extension to prevent external humidity entering the extension and the motor. This means that the wires in the extension and volute can be simpler and do not need to be able to withstand humidity. Only one submersible cable, i.e. one that is resistant to humidity, is required to supply electricity to the extension. In particular, the cable has a rubber sheath surrounding a plurality of conductors, and is, if applicable, furnished with metal braided shielding, whereas strands with their own insulating sleeve, but without a rubber sheath, are sufficient inside the extension.

It is desirable if the extension is manufactured as a cast component, this being the same for different types of pumps. To allow for the space occupied in the different types of pump by the element or elements housed in the extension, it is possible to provide an extension piece for the extension which can be stacked with the extension and interposed between the housing and the extension to increase the available space between the cover and the motor.

To ensure that the sensor for sensing a property of the impeller can access the impeller without having to pass through the motor, at least one wire passes through a chimney cast in one piece with the housing on the outer face of said housing, the wire connecting the sensor for sensing a property of the impeller to said impeller. Two chimneys are preferably provided, these being placed 180° from one another.

The extension is preferably attached to the housing such that it can be moved so that it is possible to gain access to the wired elements housed in said extension and the circuits made up of said wired elements.

One of the elements is connected by a wire to a power source on the outside by passing through a bushing in the cover.

A connecting wire that remains on the inside of the volute preferably has a simpler design than a wire leaving said volute.

It is preferable to provide a means of immobilising the element in the extension.

In the attached drawings, which are given solely by way of example:

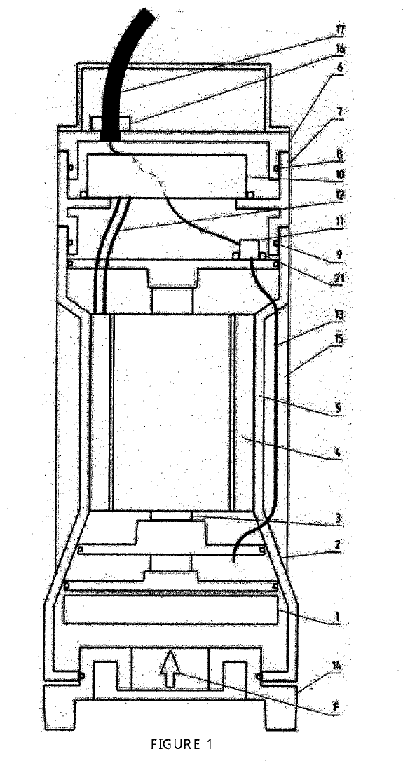

FIG. 1 shows a view as an axial cross-section of a motor pump unit according to the invention and

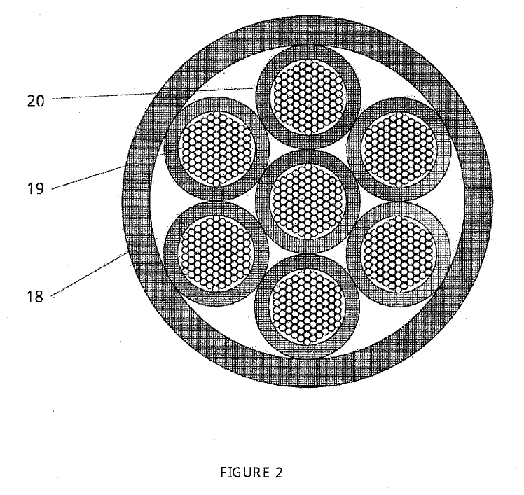

FIG. 2 shows a sectional view of a cable leaving the extension.

The motor pump unit shown in the figure comprises an impeller 1, surrounded by a volute 2 and mounted on the output shaft 3 of an electric motor 4 surrounded by a housing 5 which forms an integral part of the volute 2. The housing is closed on the side opposite the impeller 1 by a cover 6. An extension 7 is interposed between the cover 6 and the housing 5, being fixed to said housing, in a movable manner, by means of three bolts. A seal 8 ensures leaktightness between the cover 6 and the extension 7. A seal 9 ensures leaktightness between the extension 7 and the housing 5.

A control device 10 for the motor or a start capacitor 10 and a sensor 11 are housed in the space defined by the extension between the cover 6 and the housing 5. The device comprises two electrical connection wires 12 connected to the two terminals of the motor 4. The sensor 11 has one connection wire 13 which passes through a chimney 15. The chimney 15 is cast with the volute 2 and has a hole drilled in it to pass through the wire 13. A bushing 16 passes through the cover 6. A power supply cable 17 passes through the bushing 16 and connects the device. This cable is made up of a rubber sheath 18 with shielding surrounding the conductor strands 19 which are simply equipped with insulation 20, as with wires 12 and 13. Blocks 21 immobilise the elements 10 and 11 in the extension 7.

The fluid to be carried is drawn in through an opening in a suction cover 14 in the direction of the arrow F and is discharged through a nozzle, which is not shown.

1. Motor pump unit comprising an impeller surrounded by a volute and mounted on the output shaft of an electric motor surrounded by a housing which is closed on the side opposite the impeller by a cover, an extension being interposed between the cover and the housing and at least one element with an electrical connection wire being housed in the extension, characterised in that the at least one element is connected by a wire to the impeller and is a sensor for sensing a property or state of the impeller.

2. Motor pump unit according to claim 1, characterised by a seal between the extension and the housing.

3. Motor pump unit according to claim 2, characterised by a second seal between the cover and the extension.

4. Motor pump unit according to claim 1, characterised by an extension piece for the extension interposed between the housing and the extension.

5. Motor pump unit according to claim 1, characterised in that the at least one element is a probe to sense the temperature of the impeller, a sensor to sense the rotation speed of the impeller, a probe to sense the temperature of the liquid carried by the unit, a sensor to detect the difference between the discharge pressure and the suction pressure, a sensor for impeller vibrations or a probe to detect the temperature of the fluid carried by the unit or the temperature of the impeller packing boxes or bearings.

6. Motor pump unit according to claim 1, characterised in that the wire passes through a chimney cast as part of the housing on the outer face of said housing.

7. Motor pump unit according to claim 1, characterised in that the at least one element is connected by a wire to another element or to a power source outside the unit.

8. Motor pump unit according to claim 7, characterised in that a connecting wire that remains inside the volute has a more simple design than a wire leaving the unit.

9. Motor pump unit according to claim 1, characterised by a means of immobilising the element in the extension.
